(19) United States
(12) Patent Application Publication
(10) Pub. No.: US 2019/0013608 A1
(43) Pub. Date: Jan. 10, 2019

(54) FLOATING CONNECTOR DEVICE

(71) Applicant: KYOCERA CORPORATION, Kyoto (JP)

(72) Inventor: Munenobu YOSHIDA, Yamato-shi, Kanagawa (JP)

(21) Appl. No.: 16/066,625

(22) PCT Filed: Dec. 20, 2016
(86) PCT No.: PCT/JP2016/087977

§ 371 Date: Jun. 27, 2018

(30) Foreign Application Priority Data
Dec. 28, 2015 (JP) 2015-256101

(51) Int. Cl. H01R 12/91; H01R 13/631

(52) U.S. Cl. CPC H01R 12/91; H01R 13/6315

(57) ABSTRACT

A floating connector device allows movement of a movable-side housing in board-parallel and pushing directions, allows floating in a pushing/removal direction when mated with a mating connector, and has high contact reliability. A fixed housing (11) includes a long through-hole and a pair of board-facing plates. A movable housing (12) includes an outer portion projecting from the long through-hole and a retaining projection overlapping the board-facing plates in plan view. A contact group includes a tail for board mounting, a fixing portion supported by the fixed housing (11), a U-shaped portion supported by a contact support groove in the outer portion, and an elastic deformation portion, in a free state unsupported by either groove, that by its own elasticity allows the movable housing (12) to sink in a board direction, and in a sunken state, allows elastic movement in a longitudinal direction, a direction orthogonal thereto, and a tilting direction.

### CROSS-REFERENCE TO RELATED APPLICATION

The present application claims priority to and the benefit of Japanese Patent Application No. 2015-256101 filed Dec. 28, 2015, the entire contents of which are incorporated herein by reference.

### TECHNICAL FIELD

The present disclosure relates to a floating connector device mainly used as a board-to-board connector.

### BACKGROUND

A floating connector device is used for facilitating the mating of a plug connector and a receptacle connector, respectively fixed to a pair of boards, by absorbing positional error of the connectors. Either the plug connector or the receptacle connector is formed by a fixed housing (fixed insulator) fixed to a board and a movable housing (movable insulator) that is movable relative to the fixed housing. One end of a contact group is fixed to the board, and the other end is fixed to the movable housing. In other words, the movable housing is connected to the fixed housing via the contact group and can move relative to the fixed housing by the elasticity of the contact group, as in patent literature (PTL) 1, 2.

For such a floating connector device, PTL 2 proposes a technique for restricting the movement range (range of motion) of the movable housing with movement restricting brackets to prevent plastic deformation of the contact group due to excessive movement of the movable housing.

### CITATION LIST

### Patent Literature

PTL 1: JP2007265742A

PTL 2: JP201316363A

### SUMMARY

### Technical Problem

By fixing a pair of movement restricting brackets on the fixed housing in a positional relationship to clamp the movable housing, the floating connector device of PTL 2 simultaneously restricts the movement range in the alignment direction of the contacts of the movable housing and promotes retention of the movable housing. PTL 2, however, focuses on enabling the movable housing to move in a direction parallel to the board (XY direction), whereas the degree of freedom in the pushing direction (Z direction) when attaching/removing the movable housing to/from the mating connector is low. Floating is also insufficient after mating to the mating connector.

The present disclosure aims to obtain a floating connector device that can increase the range of motion of a movable-side housing not only in the direction parallel to the board but also in the pushing direction, and moreover that allows floating in the pushing and removal direction without a contact portion of the contact group sliding (moving relatively) after mating to the mating connector and that has high contact reliability.

### Solution to Problem

A floating connector device according to the present disclosure comprises a fixed housing for fixing to a board, a movable housing movable with respect to the fixed housing, and a contact group with one end for fixing in a row to the board and another end for fixing in a row to the movable housing in a longitudinal direction of the movable housing; wherein the fixed housing comprises a long through-hole and a pair of board-facing plates, positioned at longitudinal ends of the long through-hole, facing the board; the movable housing comprises an outer portion projecting from the long through-hole of the fixed housing and a retaining projection positioned farther on the board side than the board-facing plates and overlapping the board-facing plates in plan view; the contact group comprises a tail for mounting on a board, a fixing portion supported by a storage fixing groove of the fixed housing, a U-shaped portion supported by a contact support groove formed in the outer portion of the movable housing, and an elastic deformation portion, connecting the fixing portion and the U-shaped portion, in a free state unsupported by either groove; and the elastic deformation portion, by elasticity thereof in the free state, separates the movable housing from the board, allows the movable housing to sink in a direction of the board, and in a sunken state, allows elastic movement in the longitudinal direction of the movable housing, a direction orthogonal to the longitudinal direction, and a tilting direction.

In a preferred embodiment, a retaining bracket positioned on an inside of the board-facing plates is positioned on the fixed housing, and the retaining bracket comprises a pair of tails for mounting on a board, a pair of fixing portions extending along an inner surface of the fixed housing, and a retaining plate connecting the pair of fixing portions and overlapping with the retaining projection of the movable housing in plan view.

A mating connector comprising a contact group for connecting to the contact group of the floating connector device preferably comprises elastic deformation portions forming a pair including tip contact portions to elastically contact both sides of the U-shaped portion of the contact group at different height positions.

In a preferred embodiment, the elastic deformation portion of the contact group comprises an inverted U-shaped portion, a diagonally downward extension, a U-shaped fold, and a diagonally upward extension in this order from a fixing portion side that fixes to the fixed housing.

The contact group preferably further comprises a floating deforming portion, between the fixing portion that fixes to the fixed housing and the inverted U-shaped portion, separated from a bottom of the storage fixing groove of the fixed housing.

### Advantageous Effect

The present disclosure can obtain a floating connector device that can increase the range of motion of a movable-side housing not only in the direction parallel to the board but also in the pushing and removal direction, and moreover that allows floating in the pushing and removal direction after mating to a mating connector and that has high contact reliability.

### BRIEF DESCRIPTION OF THE DRAWINGS

In the accompanying drawings:

FIG. 1 is a perspective view of a plug connector (floating connector) alone, illustrating an embodiment of a floating connector device according to the present disclosure;

FIG. 2 is a perspective view from the opposite direction of the same plug connector alone;

FIG. 3 is a perspective view from the opposite direction of a movable housing of the same plug connector;

FIG. 4 is a cross-sectional view along the IV-IV line in FIG. 1;

FIG. 5 is a cross-sectional view along the V-V line in FIG. 1;

FIG. 6 is a cross-sectional view along the VI-VI line in FIG. 1;

FIG. 7 is a perspective view of an embodiment of a receptacle connector for coupling to the plug connector of FIG. 1 through FIG. 6, illustrating an embodiment of a floating connector device according to the present disclosure;

FIG. 8 is a cross-sectional view along the VII-VII line in FIG. 7; and

FIG. 9 is a cross-sectional view corresponding to FIG. 6 and FIG. 8, illustrating a state of connection between the plug connector in FIG. 1 through FIG. 6 and the receptacle connector in FIG. 7 and FIG. 8.

### DETAILED DESCRIPTION

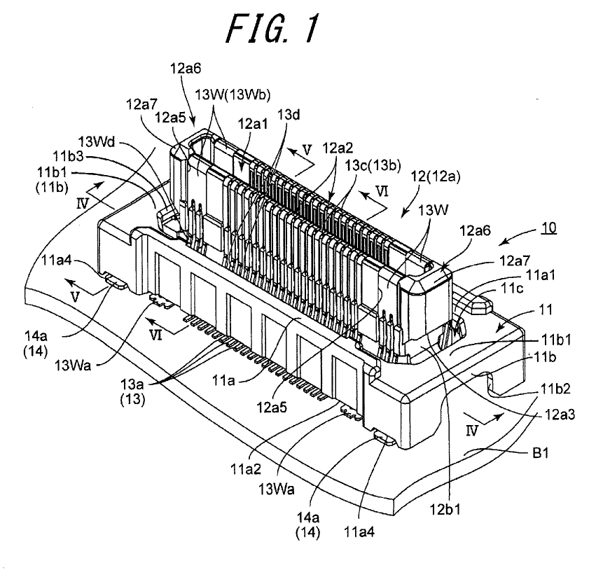

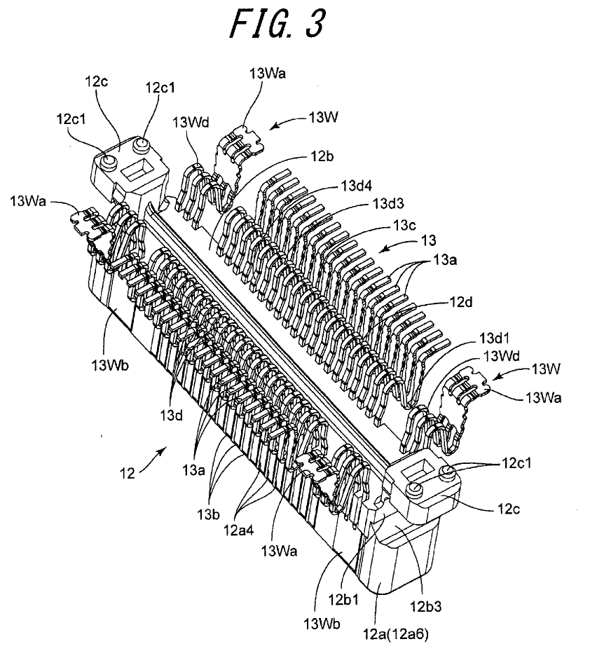

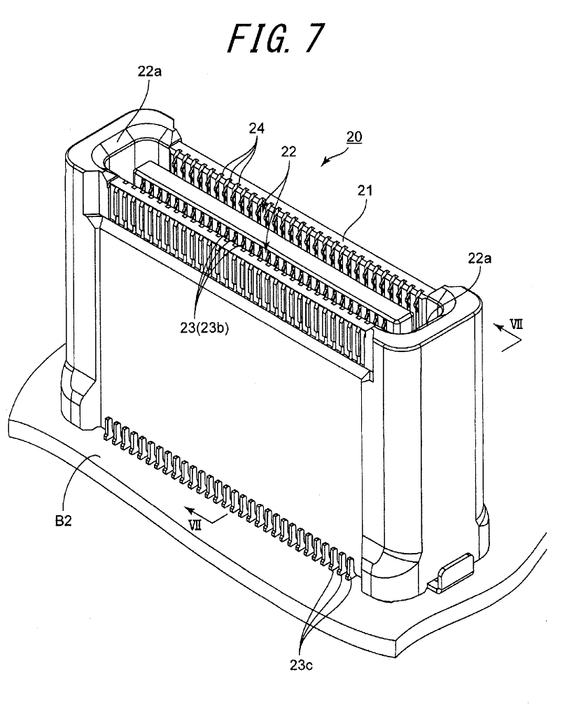

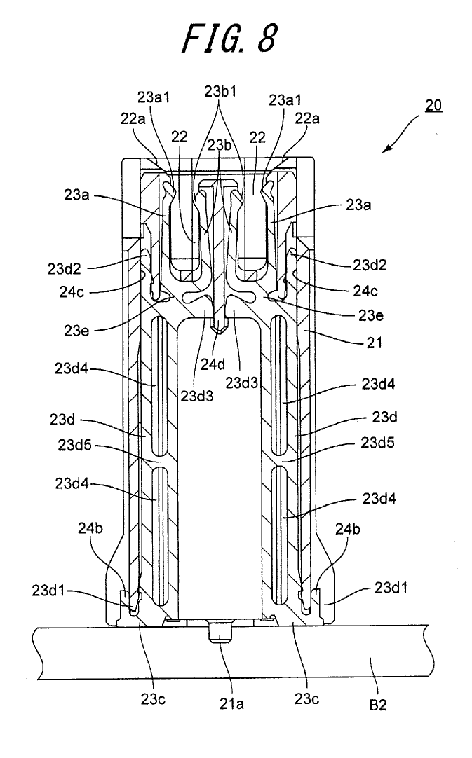

A connector (plug connector in the present embodiment) 10 illustrated in FIG. 1 through FIG. 6 and FIG. 9 and a connector (receptacle connector in the present embodiment) 20 illustrated in FIG. 7 through FIG. 9 are connected by mating. Of these two connectors, the plug connector 10 is illustrated in the present embodiment as being a floating connector device. In the present embodiment, a first board B1 (circuit board, control board) and a second board B2 (circuit board, control board) are parallel in a regular state (design state). A wiring circuit on the first board B1 is mounted on and coupled to a plug contact 13 group of the plug connector 10 in advance. A wiring circuit on the second board B2 is mounted on and coupled to a receptacle contact 23 group of the receptacle connector 20 in advance.

As illustrated in FIG. 1 through FIG. 6, the plug connector 10 includes a fixed (guide) housing (fixed insulator) 11 mounted on the first board B1, a movable housing (movable insulator) 12 supported movably by the fixed housing 11, and a plug contact 13 group mounted between the movable housing 12 and the first board B1. The alignment direction of the plug contact 13 group is the longitudinal direction of the plug connector 10 (fixed housing 11 and movable housing 12). In the present embodiment, the plug connector 10 and the receptacle connector 20 are symmetrical relative to an up-down center line (plane) X (FIG. 6) along the longitudinal direction. The direction away from the first board B1 (second board B2) is upward.

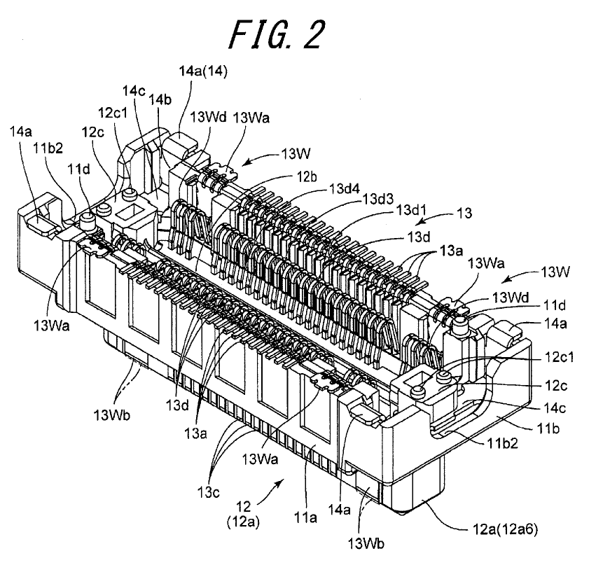

The fixed housing 11 has the shape of a planar rectangular frame that includes a pair of parallel longitudinal walls 11a in the longitudinal direction rising from the first board B1 and a pair of parallel transverse walls 11b in the transverse direction connecting the ends of the pair of longitudinal walls 11a. The longitudinal walls 11a and the transverse walls 11b have the same height. An opening restriction edge (projection) 11a1 facing inward is formed near the upper end of the longitudinal walls 11a (FIG. 1, FIG. 6). A board-facing plate (board parallel plate) 11b1 facing inward is formed at the upper end of the transverse walls 11b. A long through-hole 11c (FIG. 1) is formed by the opening restriction edges (projections) 11a1 and the board-facing plates 11b1. A cutout 11a2 exposing a tail 13a of the plug contact 13 is formed in a portion of the longitudinal wall 11a along the first board B1 at the central portion in the longitudinal direction. An opening 11b2 is formed at the central portion of the transverse wall 11b on the first board B1 side. A positioning projection 11d for positioning to the first board B1 is formed on a portion of the lower end of the longitudinal wall 11a of the fixed housing 11 (FIG. 2, FIG. 6).

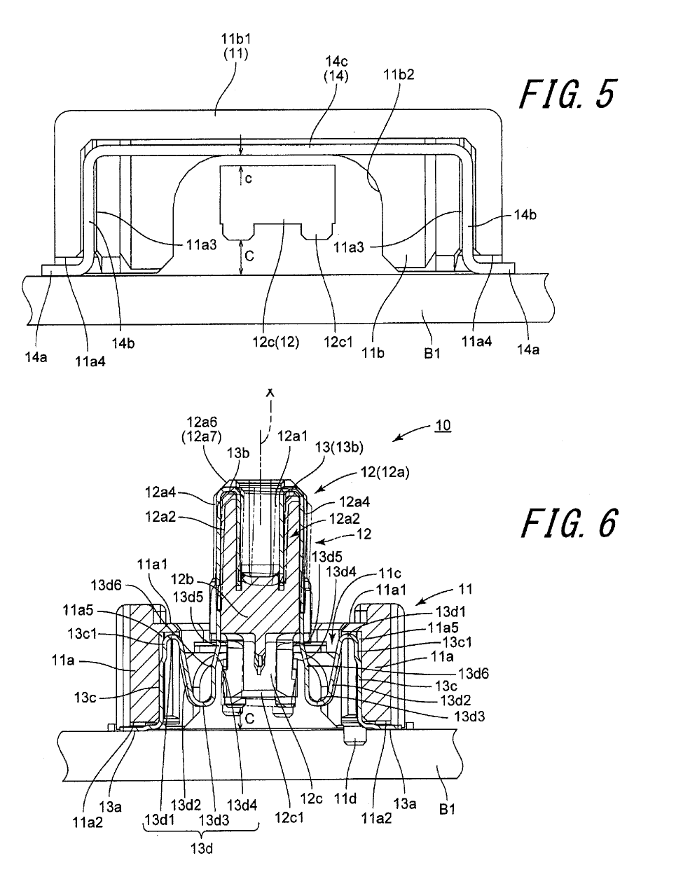

At both longitudinal ends of the fixed housing 11, a substantially U-shaped retaining bracket 14 is positioned on the inner surface of the pair of longitudinal walls 11a and the board-facing plate 11b1 of the transverse wall 11b. This retaining bracket 14 has a pair of tails 14a mounted (soldered) to the first board B1, a fixing portion 14b that rises from each tail 14a and fits in a storage fixing groove 11a3 (FIG. 5) on the inner surface of the longitudinal wall 11a, and a retaining plate 14c that connects the upper ends of the pair of fixing portions 14b. The retaining plate 14c is disposed along the inner surface of the board-facing plate 11b1. A cutout 11a4 exposing the tail 14a is formed on the longitudinal wall 11a.

The movable housing 12 includes an outer portion 12a positioned (projecting) on the outside of the fixed housing 11 and an inner portion 12b extending from the outer portion 12a into the long through-hole 11c. At both longitudinal ends of the inner portion 12b, a stopper face 12b1 for restricting the movement end of the movable housing 12 in the longitudinal direction is formed facing the board-facing plate 11b1 (the inner surface of the long through-hole 11c) of the fixed housing 11.

At both longitudinal ends of the inner portion 12b, a pair of retaining projections 12c are formed at a position below the board-facing plate 11b1 of the fixed housing 11 and the retaining plate 14c of the retaining bracket 14 (in a regular state, a portion of the tip overlaps with the board-facing plate 11b1 and the retaining plate 14c in plan view). An escape space 12d in which the board-facing plate 11b1 can move freely is formed between the outer portion 12a and the retaining projection 12c. In a regular state, the upper surface of the retaining projection 12c opposes the retaining plate 14c of the retaining bracket 14 with a clearance c (FIG. 5). The size of this clearance c is, for example, 0.15 mm. Stopper projections 12c1 for restricting the downward movement end of the movable housing 12 are formed on the lower end of the retaining projection 12c, facing the first board B1. A gap C between the stopper projections 12c1 and the first board B1 is, for example, 0.6 mm (FIG. 5, FIG. 6). The gap C is preferably larger than the clearance c but may be identical to or smaller than the clearance c.

In other words, the amount of movement (movement end) of the movable housing 12 in the longitudinal direction is restricted by the position of abutment with the stopper face 12b1 and the inner surface of the board-facing plate 11b1. The amount of movement (movement end) in the left-right direction is restricted by the position of abutment with the outer surface of the inner portion 12b and the opening restriction edge (projection) 11a1. The amount of movement (movement end) upward is restricted by the position of abutment between the upper surface of the retaining projections 12c and the retaining plate 14c of the retaining brackets 14. The amount of movement (movement end) downward is restricted by the position of abutment between the stopper projections 12c1 of the retaining projections 12c and the first board B1.

A long bottomed hole 12a1 extending in the longitudinal direction is formed in the central portion in the transverse direction of the outer portion 12a. Longitudinal direction plates at both ends of this long bottomed hole 12a1 form a pair of insertion plates 12a2. Contact support grooves 12a4 for insertion and fixing of a row of plug contacts 13 are formed in a row on the inside and outside of the insertion plates 12a2. A U-shaped portion 13b of the plug contact 13 is inserted and fixed to each contact support groove 12a4.

A guiding projection 12a6 that projects upward and sideways is formed at both longitudinal ends of the outer portion 12a. A guiding inclined face 12a7 is formed on the outer surface at the upper end. A tapered face 12a3 that is positioned below the guiding projection 12a6 and decreases in longitudinal width (length) towards the inner portion 12b is formed in the escape space 12d below the longitudinal ends of the outer portion 12a of the movable housing 12.

On the other hand, a chamfered portion 11b3 opposing the tapered face 12a3 is formed in the transverse wall 11b of the fixed housing 11 on the inner edge of the board-facing plate 11b1 that opposes the tapered face 12a3. The tapered face 12a3 and the chamfered portion 11b3 are normally not in contact, but when the movable housing 12 relatively moves and swings excessively, the tapered face 12a3 and the chamfered portion 11b3 can come into surface contact to restrict the swinging.

Two rows of plug contacts 13 are provided along with a pair of insertion plates 12a2 (corresponding to the pair of longitudinal walls 11a of the fixed housing 11). Each plug contact 13 includes the above-described tail 13a (FIG. 6) mounted on the first board B1, a fixing portion 13c that fits in storage fixing grooves 11a5 formed in a row on the inner surface of the longitudinal wall 11a of the fixed housing 11, and an elastic deformation portion 13d continuous with the above-described U-shaped portion 13b. A floating deforming portion 13c1 connecting the upper end of the fixing portion 13c smoothly to the elastic deformation portion 13d is formed on the upper end of the fixing portion 13c separated from the bottom of the storage fixing groove 11a5.

The elastic deformation portion 13d is a portion that does not engage with (is not inserted into) any support groove (deformation suppressing groove), including the storage fixing groove 11a5 of the fixed housing 11 and the contact support groove 12a4 of the movable housing 12, and can freely deform elastically. The elastic deformation portion 13d includes an inverted U-shaped portion 13d1, a diagonally downward extension 13d2, a U-shaped fold 13d3, and a diagonally upward extension 13d4 in this order from the fixing portion 13c (floating deforming portion 13c1) side. Elastic deformation of this elastic deformation portion 13d (particularly the inverted U-shaped portion 13d1, U-shaped fold 13d3, and diagonally upward extension 13d4) allows floating in the up-down direction, longitudinal direction, and left-right direction of the movable housing 12 and also in a rotation direction about (a location near) the plane center of the movable housing 12.

A wide U-shaped portion 13Wb of a wide plug contact 13W is positioned on the movable housing 12 at the ends of the plug contacts 13 positioned in a row. This wide plug contact 13W can be used as a ground terminal or a power source terminal. A wide contact support groove 12a5 for insertion of the U-shaped portion 13Wb is formed in the insertion plate 12a2. A tail 13Wa of the wide plug contact 13W is also wide. However, an elastic deformation portion 13Wd positioned between the tail 13Wa and the U-shaped portion 13Wb is divided into narrow portions of the same width as the elastic deformation portion 13d of another plug contact (signal contact) 13. Accordingly, the wide plug contact 13W does not interfere with elastic deformation of the movable housing 12.

The plug connector 10 is thus structured so that when no external force is applied to the movable housing 12, the movable housing 12 is correctly positioned at the center of the fixed housing 11 by the elastic force of the plug contact 13, 13W group positioned symmetrically with respect to the central plane X. The pair of retaining projections 12c at the ends thereof are positioned symmetrically below the board-facing plate 11b1 of the fixed housing 11. The upper surface of the retaining projections 12c opposes the retaining plate 14c of the retaining bracket 14 with the clearance c (FIG. 5).

The receptacle connector 20 includes an insulator housing 21 in the shape of a rectangular parallelepiped having a planar shape slightly larger than the outer portion 12a of the movable housing 12 in plan view, as illustrated in FIG. 7 through FIG. 9. A pair of receptacle recesses 22 for receiving the pair of insertion plates 12a2 of the movable housing 12 is formed in the housing 21. A row of storage grooves 24 for receiving the receptacle contacts 23 is formed in the receptacle recesses 22. Guiding inclined faces 22a, corresponding to the guiding projection 12a6 and the guiding inclined face 12a7 formed on the outer surface at the upper end of the outer portion 12a of the movable housing 12, are formed at the entrances to the receptacle recesses 22. A positioning projection 21a is formed at the end of the housing 21 on the second board B2 side.

The receptacle contacts 23 stored in the pair of receptacle recesses 22 have the same (horizontal inversion) shape. The receptacle contact 23 has elastic deformation portions 23a, 23b projecting from the opposing inner surfaces of the receptacle recesses 22, a tail 23c soldered to the second board B2, and a connection fixing portion 23d that connects the elastic deformation portions 23a, 23b and the tail 23c. The elastic deformation portions 23a, 23b and the connection fixing portion 23d are connected by a constricted (narrow) linking portion 23e. The elastic deformation portions 23a, 23b are positioned inside a deformation allowance groove 24a that faces the opposing inner surfaces of the receptacle recesses 22. The positions of tip contact portions 23a1, 23b1 in the depth direction of the receptacle recesses 22 differ from each other. The elastic deformation portion 23a (tip contact portion 23a1) and the elastic deformation portion 23b (tip contact portion 23b1) elastically contact both sides of the U-shaped portion 13b of the plug contact 13 when the insertion plates 12a2 of the movable housing 12 are inserted in the receptacle recesses 22. By varying the positions of tip contact portions 23a1, 23b1 in the depth direction of the receptacle recesses 22, the tip contact portions 23a1, 23b1 contact (abut) the U-shaped portion 13b at different times when inserted and fit into the plug contacts 13. This mitigates the insertion force. Furthermore, the probability of contact failure when a foreign object adheres to the U-shaped portion 13b of the plug contacts 13 is reduced by the U-shaped portion 13b being clamped from both sides. The position of either one of the tip contact portions 23a1, 23b1 in the depth direction of the receptacle recesses 22 may be shallower, but the position of the tip contact portion 23a1 on the outside is preferably shallower from the perspective of guiding the fitting.

The elastic deformation portions 23a, 23b can not only elastically deform alone in the contact and separation direction, but they can also elastically move integrally in a plane that includes the contact and separation direction by elastic deformation of the linking portion 23e.

The connection fixing portion 23d has two slits 23d4 that are separated in the longitudinal direction (up-down direction). Since the connection fixing portion 23d is divided by the slits 23d4 into two conductive portions extending in the longitudinal direction, the high-frequency characteristics improve. One slit 23d4 or three or more in a line may be included, but inclusion of a connecting portion 23d5 between slits 23d4 ensures strength.

The housing 21 (storage grooves 24) and the receptacle contacts 23 are provided with a fixing structure that allows the above-described elastic deformation of the elastic deformation portions 23a, 23b of the receptacle contacts 23 while reliably fixing the connection fixing portion 23d to the housing 21. In other words, a fixing projection 24b and a fixing recess 23d1 are formed on the tail 23c side. Furthermore, a fixing recess 24c and fixing projection 23d2, along with a separation wall 24d and a movement restricting portion 23d3, are formed on the elastic deformation portion 23a, 23b side.

The receptacle contact 23 group is not provided with wide contacts corresponding to the wide plug contacts 13W in the plug contact 13 group on the movable housing 12 side. A specific number (three rows in this embodiment) of receptacle contacts 23 at either side of the receptacle contact 23 group contact the wide plug contacts 13W. Wide contacts corresponding to the wide plug contacts 13W may be provided at either side of the receptacle contact 23 group.

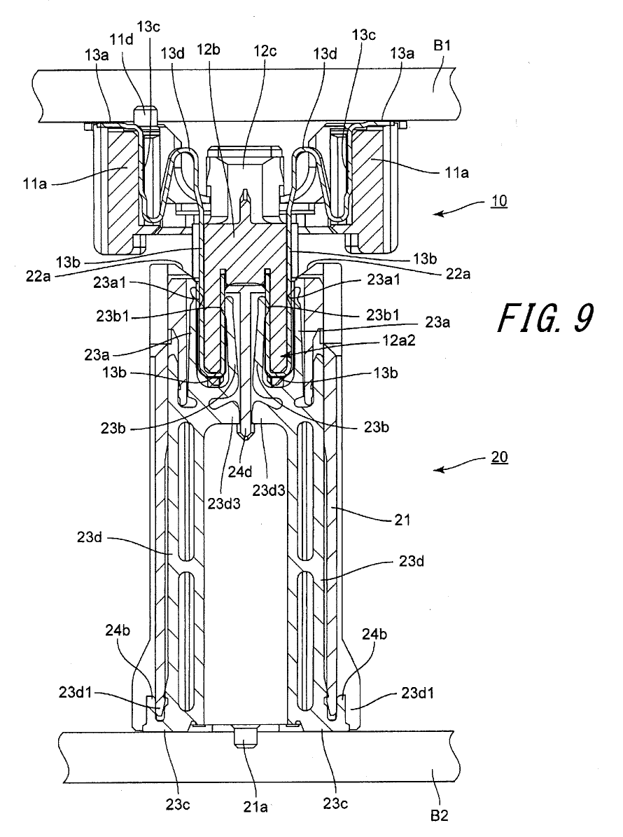

When connecting the above-described plug connector 10 (first board B1) and receptacle connector 20 (second board B2), the pair of insertion plates 12a2 of the movable housing 12 are mated with the pair of receptacle recesses 22 of the housing 21. At this time, the guiding inclined face 22a of the entrance to the receptacle recess 22 engages with the guiding projection 12a6 and the guiding inclined face 12a7 of the outer portion 12a of the movable housing 12, and the insertion plates 12a2 can be smoothly guided into the receptacle recesses 22. The plug contact 13 group supported by the insertion plates 12a2 then becomes conductive while causing the elastic deformation portions 23a, 23b of the receptacle contacts 23, which are exposed inside the receptacle recesses 22, to deform elastically. Consequently, the circuit on the first board B1 and the circuit on the second board B2 are connected. FIG. 9 illustrates the elastic deformation portions 23a, 23b of the receptacle contact 23 in a free state without elastic deformation.

During this insertion and connection operation, a force acts on the movable housing 12 downward and in another direction, so that the elastic deformation portion 13d of the plug contact 13 deforms elastically. In particular, the movable housing 12 is movable in the sinking direction in the present embodiment. Hence, a tilting or rotating movement is possible in the sunken state, allowing the connection operation to be performed smoothly. In greater detail, the elastic deformation portion 13d is a portion that does not engage with (is not inserted into) any support groove (deformation suppressing groove), including the storage fixing groove 11a5 of the fixed housing 11 and the contact support groove 12a4 of the movable housing 12, and can freely deform elastically, as described above. Floating in the longitudinal direction of the movable housing 12 is produced by elastic deformation in a direction perpendicular to the paper (drawing surface) in FIG. 6, which illustrates the elastic deformation portion 13d of the plug contact 13. Floating in the sinking direction (the pushing direction, which approaches the first board B1), the left-right direction (including torsional motion), and the rotation direction is produced by elastic deformation of the inverted U-shaped portion 13d1 in the left-right direction and elastic deformation of the diagonally downward extension 13d2, U-shaped fold 13d3, and diagonally upward extension 13d4. At this time, the diagonally upward extension 13d4 heightens the function of facilitating elastic deformation and left-right movement of the U-shaped fold 13d3. In greater detail, a connecting portion 13d5 connecting the lower end of the U-shaped portion 13b and the diagonally upward extension 13d4 illustrated in FIG. 6, or some location inside the diagonally upward extension 13d4, becomes a pivot point, and the angle of a connecting portion (bent portion) 13d6 between the diagonally upward extension 13d4 and the U-shaped fold 13d3 changes. As a result, stress is dispersed, and swinging of the elastic deformation portion 13d is facilitated. The bent portion 13d6 may also occur somewhere in the diagonally upward extension 13d4 or somewhere in the U-shaped fold 13d3. Furthermore, since the floating deforming portion 13c1 is separated from the longitudinal walls 11a, the left-right movement of the inverted U-shaped portion 13d1 itself is not restricted. Accordingly, the elastic deformation portion 13d allows flexible movement particularly in the up-down direction of the movable housing 12.

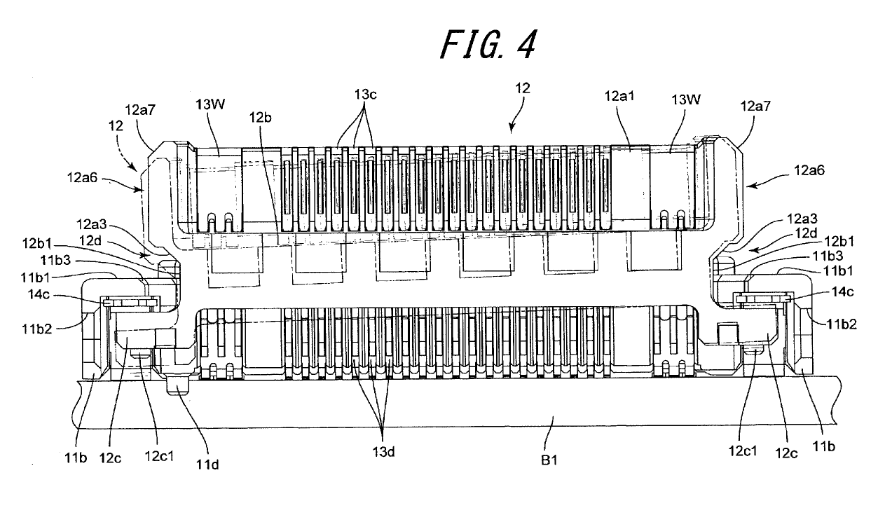

By the above-described elastic deformation of the elastic deformation portion 13d and the floating deforming portion 13c1, the contact state between the U-shaped fold 13d3 and the tip contact portions 23a1, 23b1 can be maintained, and the movable housing 12 and fixed housing 11 can float in a state without relative movement of the contact portion (a state in which the contact portion does not slide). In FIG. 4 and FIG. 6, the floating movable housing 12 is indicated by dashed double-dotted lines, excluding the plug contacts 13 and the like.

The downward movement end of the movable housing 12 is restricted by the position of abutment between the stopper projections 12c1 of the retaining projection 12c and the first board B1. The movement end of the movable housing 12 in the longitudinal direction and the left-right direction is restricted by the position of abutment between the stopper face 12b1 and the inner surface of the board-facing plate 11b1. The amount of movement in the left-right direction is restricted by the position of abutment between the outer surface of the inner portion 12b and the opening restriction edge (projection) 11a1. The elastic force of the elastic deformation portion 13d of the plug contact 13 may, however, be adjusted so that the plug connector 10 and the receptacle connector 20 can be completely mated without the retaining projection 12c reaching the position of abutment (restriction position) with the first board B1. The movable housing 12 thus being movable in the pushing and removal direction increases the tolerance with respect to misalignment of the first board B1 and second board B2. The risk of connector damage due to a colliding force at the time of fitting can also be avoided.

On the other hand, when removing the plug connector 10 from the receptacle connector 20, the movable housing 12 moves upward relative to the fixed housing 11. The upward movement end of this movement is restricted by the position of abutment between the upper surface of the retaining projections 12c and the retaining plate 14c of the retaining bracket 14. A reduction in size of the fixed housing 11 is desired, and thinning of the board-facing plate 11b1 is also required. Promoting retention of the retaining projection 12c of the movable housing 12 with the retaining plate 14c of the retaining bracket 14 in this way reliably promotes retention without risk of damage to the fixed housing 11 (board-facing plate 11b1).

When the amount of floating is large (in this example, an allowable movement of approximately 1 mm to one side in the longitudinal direction relative to a pitch of 0.5 mm) during mating while floating the movable housing 12 relative to the fixed housing 11, the amount of deformation of the elastic deformation portion 13d in the plug contact 13, which is four-cornered in plan view of the movable housing 12, increases. Hence, the distance between adjacent plug contacts 13 might become extremely small. The wide plug contact 13W as one plug contact that has a plurality of elastic deformation portions 13Wd is disposed at the four corners of the movable housing 12, thereby allowing use for protecting the narrow (signal transmission) plug contacts 13 in the intermediate portion. In other words, providing the plurality of elastic deformation portions 13Wd (three in the illustrated embodiment) relative to one U-shaped portion 13Wb of the wide plug contact 13W can protect the narrow (signal transmission) plug contacts 13 in the intermediate portion without sacrificing floatability. One of the wide plug contacts 13W can also be used as one circuit, as a ground terminal or a power source terminal.

The position of the tip of the wide plug contact 13W in the mating direction may be shifted from the position of the tip of the plug contact 13. For example, when used as a ground terminal, the wide plug contact 13W is preferably contacted to the receptacle contact 23 before the remaining narrow (signal transmission) plug contacts 13 during connection of the plug connector 10 and the receptacle connector 20. Therefore, as illustrated by the dashed line in FIG. 2, the wide plug contact 13W can come into contact first with the tip of the corresponding ground terminal among the receptacle contacts 23 by the U-shaped portion 13Wb being formed with a greater upward projection amount than the upward projection amount of the U-shaped portion 13b of the narrow (signal transmission) plug contacts 13. The receptacle contact 23 is contacted by the wide plug contact 13W and then by the narrow (signal transmission) plug contacts 13, so that grounding has already been achieved when a signal flows to the narrow (signal transmission) plug contacts 13.

When the wide plug contact 13W is used as a power source terminal, the remaining narrow (signal transmission) plug contacts 13 first contact the receptacle contacts 23, with the wide plug contact 13W subsequently contacting the receptacle contact 23, during connection of the plug connector 10 and the receptacle connector 20. This order of contact allows power to flow after the narrow (signal transmission) plug contacts 13 contact the receptacle contact 23. In other words, all of the narrow (signal transmission) plug contacts 13 are in a state capable of conduction when power flows. In this case, the wide plug contact 13W can come into contact later with the corresponding power source terminal among the receptacle contacts 23 by the U-shaped portion 13Wb of the wide plug contact 13W being formed with a smaller upward projection amount than the upward projection amount of the U-shaped portion 13b of the narrow (signal transmission) plug contacts 13.

One of the wide plug contacts 13W in the pair may be the aforementioned ground terminal, and the other may be the aforementioned power source terminal.

An example of the fixing structure of the receptacle contact 23 to the housing 21 (storage grooves 24) has been illustrated with the above embodiment, but modifications are possible. In particular, the second board B2 and the first board B1 are parallel in the illustrated example. However, the second board B2 and the first board B1 may be orthogonal to each other. In this case, the connection fixing portion 23d (and the housing 21 and storage grooves 24) may be changed to a corresponding shape.

The plug connector 10 is formed by the fixed housing 11 and the movable housing 12 in the above embodiment, but the receptacle connector 20 side may be formed by a fixed housing and a movable housing.

### REFERENCE SIGNS LIST

B1 First board (board)
B2 Second board (board)
10 Plug connector (floating connector device)
11 Fixed housing
11a Longitudinal wall
11a1 Opening restriction edge (projection)
11a2 Cutout
11a3 Storage fixing groove
11a4 Cutout
11a5 Storage fixing groove
11b Transverse wall
11b1 Board-facing plate
11b2 Opening
11b3 Chamfered portion
11c Long through-hole
11d Positioning projection
12 Movable housing
12a Outer portion
12a1 Long bottomed hole
12a2 Insertion plate
12a3 Tapered face
12a4 Contact support groove
12a5 Wide contact support groove
12a6 Guiding projection
12a7 Guiding inclined face
12b Inner portion
12b1 Stopper face
12c Retaining projection
12c1 Stopper projection
13 Plug contact (contact group)
13W Wide plug contact
13a, 13Wa Tail
13b, 13Wb U-shaped portion
13c Fixing portion
13c1 Floating deforming portion
13d Elastic deformation portion
13d1 Inverted U-shaped portion
13d2 Diagonally downward extension
13d3 U-shaped fold
13d4 Diagonally upward extension
14 Retaining bracket
14a Tail
14b Fixing portion
14c Retaining plate
20 Receptacle connector
21 Housing
22 Receptacle recess
23 Receptacle contact (contact group)
23a, 23b Elastic deformation portion
23a1, 23b1 Tip contact portion
23c Tail
23d Connection fixing portion
23d1 Fixing recess
23d2 Fixing projection
23d3 Movement restricting portion
23d4 Slit
23d5 Connecting portion
23e Linking portion
24 Storage groove
24a Deformation allowance groove
24b Fixing projection
24c Fixing recess
24d Separation wall

1. A floating connector device comprising a fixed housing for fixing to a board, a movable housing movable with respect to said fixed housing, and a contact group with one end for fixing in a row to said board and another end for fixing in a row to said movable housing in a longitudinal direction of said movable housing; wherein
said fixed housing comprises a long through-hole and a pair of board-facing plates, positioned at longitudinal ends of said long through-hole, facing said board;
said movable housing comprises an outer portion projecting from said long through-hole of said fixed housing and a retaining projection positioned farther on the board side than said board-facing plates and overlapping said board-facing plates in plan view;
said contact group comprises a tail for mounting on a board, a fixing portion supported by a storage fixing groove of said fixed housing, a U-shaped portion supported by a contact support groove formed in said outer portion of said movable housing, and an elastic deformation portion, connecting said fixing portion and said U-shaped portion, in a free state unsupported by either groove; and
said elastic deformation portion, by elasticity thereof in said free state, separates said movable housing from said board, allows said movable housing to sink in a direction of the board, and in a sunken state, allows elastic movement in said longitudinal direction of said movable housing, a direction orthogonal to said longitudinal direction, and a tilting direction.

2. The floating connector device of claim 1, wherein a retaining bracket positioned on an inside of said board-facing plates is positioned on said fixed housing, and said retaining bracket comprises a pair of tails for mounting on a board, a pair of fixing portions extending along an inner surface of said fixed housing, and a retaining plate connecting said pair of fixing portions and overlapping with said retaining projection of said movable housing in plan view.

3. The floating connector device of claim 1, wherein a mating connector comprising a contact group for connecting to said contact group of said floating connector device comprises elastic deformation portions forming a pair including tip contact portions to elastically contact both sides of said U-shaped portion of said contact group at different height positions.

4. The floating connector device of claim 1, wherein said elastic deformation portion of said contact group comprises an inverted U-shaped portion, a diagonally downward extension, a U-shaped fold, and a diagonally upward extension in this order from a fixing portion side that fixes to said fixed housing.

5. The floating connector device of claim 4, wherein said contact group comprises a floating deforming portion, between said fixing portion that fixes to said fixed housing and said inverted U-shaped portion, separated from a bottom of said storage fixing groove of said fixed housing.
